(19) United States
(12) Patent Application Publication
(10) Pub. No.: US 2025/0284727 A1
(43) Pub. Date: Sep. 11, 2025

(54) DATA QUALITY ASSESSMENT AND TRANSFORMATION IN A PRIVACY PRESERVING FEDERATED SYSTEM

(71) Applicant: INTERNATIONAL BUSINESS MACHINES CORPORATION, ARMONK, NY (US)

(72) Inventors: Anisa Halimi, Dublin (IE); Kieran Fraser, Raheny (IE); Liubov Nedoshivina, Dublin (IE); Stefano Braghin, Dublin (IE)

(21) Appl. No.: 18/595,827

(22) Filed: Mar. 5, 2024

(51) Int. Cl. G06F 16/36; G06F 16/383; G06F 21/62

(52) U.S. Cl. CPC G06F 16/367; G06F 16/383; G06F 21/6245

(57) ABSTRACT

A computer-implemented method for automatically transforming client data to a common data normalization schema associated with a collaborative multi-client federated learning system while preserving data privacy. The method may include automatically generating a local data ontology based on the client data associated with a client, and automatically generating synthetic data based on the client data and the local data ontology. The method may also include automatically computing an inference risk score comprising determining a privacy risk associated with sharing the synthetic data, and automatically computing a task utility score comprising determining a utility of the synthetic data. The method may further include generating a global data ontology using ontology matching algorithms on the synthetic data associated with each local data ontology. The method may also include automatically recommending and implementing data transformations to the client data.

### BACKGROUND

The present invention relates generally to the field of computing, and more specifically, to automatically transforming client data to a common data normalization schema while preserving data privacy in a collaborative multi-client federated learning system.

Generally, federated learning (FL), also known as collaborative learning, is a decentralized approach to training machine learning models. Specifically, (FL) is a distributed machine learning (ML) paradigm where a global model is trained from data distributed at multiple client sites without sharing the raw data of the clients. The global model is trained through an iterative procedure where clients locally train a ML model, send the locally trained parameters to a server for aggregation, and the server sends the aggregated model parameters to the clients, which then train the ML model from the received aggregated model parameters in the next iteration Thus, FL is a sub-field of machine learning in which multiple entities or clients collaboratively train a machine learning model while ensuring that client data from each client remains decentralized. The general principle consists in training local models on local data samples and exchanging parameters (e.g. the weights and biases of a deep neural network) between these local nodes to generate a global model that may be shared by all nodes. As such, while previously many of the artificial intelligence (AI) applications were trained on data gathered and crunched in one place, today's AI applications have been shifting toward this federated decentralized approach where AI models are being trained collaboratively on the edge and on data that may never leave one's client device such as a mobile phone, laptop, or private server.

### SUMMARY

A computer-implemented method for automatically transforming client data to a common data normalization schema associated with a collaborative multi-client federated learning system while preserving data privacy is provided. The method may include, for a client in the collaborative multi-client federated learning system comprising a plurality of clients, automatically generating a local data ontology based on client data associated with the client, and automatically generating synthetic data based on the client data and the local data ontology. The method may also include automatically computing an inference risk score and computing a task utility score for the synthetic data using one or more machine learning (ML) algorithms, wherein computing the inference risk score further comprises determining a privacy risk associated with sharing the synthetic data, and wherein computing the task utility score further comprises determining a utility of the synthetic data. The method may further include, based on the inference risk score and the task utility score, generating a global data ontology using ontology matching algorithms on the synthetic data associated with each local data ontology generated from each client from the plurality of clients in the collaborative multi-client federated learning system. The method may also include, based on the generated global data ontology, automatically recommending and implementing data transformations to the client data, wherein automatically recommending and implementing the data transformations further comprises automatically transforming the client data to the common data normalization schema based the global data ontology.

A computer system for automatically transforming client data to a common data normalization schema associated with a collaborative multi-client federated learning system while preserving data privacy is provided. The computer system may include one or more processors, one or more computer-readable memories, one or more computer-readable tangible storage devices, and program instructions stored on at least one of the one or more storage devices for execution by at least one of the one or more processors via at least one of the one or more memories, whereby the computer system is capable of performing a method. The method may include, for a client in the collaborative multi-client federated learning system comprising a plurality of clients, automatically generating a local data ontology based on client data associated with the client, and automatically generating synthetic data based on the client data and the local data ontology. The method may also include automatically computing an inference risk score and computing a task utility score for the synthetic data using one or more machine learning (ML) algorithms, wherein computing the inference risk score further comprises determining a privacy risk associated with sharing the synthetic data, and wherein computing the task utility score further comprises determining a utility of the synthetic data. The method may further include, based on the inference risk score and the task utility score, generating a global data ontology using ontology matching algorithms on the synthetic data associated with each local data ontology generated from each client from the plurality of clients in the collaborative multi-client federated learning system. The method may also include, based on the generated global data ontology, automatically recommending and implementing data transformations to the client data, wherein automatically recommending and implementing the data transformations further comprises automatically transforming the client data to the common data normalization schema based the global data ontology.

A computer program product for automatically transforming client data to a common data normalization schema associated with a collaborative multi-client federated learning system while preserving data privacy is provided. The computer program product may include one or more computer-readable storage devices and program instructions stored on at least one of the one or more tangible storage devices, the program instructions executable by a processor. The computer program product may include program instructions to, for a client in the collaborative multi-client federated learning system comprising a plurality of clients, automatically generate a local data ontology based on client data associated with the client, and automatically generating synthetic data based on the client data and the local data ontology. The computer program product may also include program instructions to automatically compute an inference risk score and computing a task utility score for the synthetic data using one or more machine learning (ML) algorithms, wherein computing the inference risk score further comprises determining a privacy risk associated with sharing the synthetic data, and wherein computing the task utility score further comprises determining a utility of the synthetic data. The computer program product may further include program instructions to, based on the inference risk score and the task utility score, generate a global data ontology using ontology matching algorithms on the synthetic data associated with each local data ontology generated from each client from the plurality of clients in the collaborative multi-client federated learning system. The computer program product may also include program instructions to, based on the generated global data ontology, automatically recommend and implement data transformations to the client data, wherein automatically recommending and implementing the data transformations further comprises automatically transforming the client data to the common data normalization schema based the global data ontology.

### BRIEF DESCRIPTION OF THE SEVERAL VIEWS OF THE DRAWINGS

These and other objects, features and advantages of the present invention will become apparent from the following detailed description of illustrative embodiments thereof, which is to be read in connection with the accompanying drawings. The various features of the drawings are not to scale as the illustrations are for clarity in facilitating one skilled in the art in understanding the invention in conjunction with the detailed description. In the drawings:

FIG. 1 illustrates an exemplary computing environment according to one embodiment;

FIG. 2 is a diagram illustrating system components of a data quality assessment and transformation program for automatically transforming client data to a common data normalization schema associated with a collaborative multi-client federated learning system while preserving data privacy according to one embodiment;

FIG. 3 is an operational flowchart for a program for automatically transforming client data to a common data normalization schema associated with a collaborative multi-client federated learning system while preserving data privacy according to one embodiment.

### DETAILED DESCRIPTION

Detailed embodiments of the claimed structures and methods are disclosed herein; however, it can be understood that the disclosed embodiments are merely illustrative of the claimed structures and methods that may be embodied in various forms. This invention may, however, be embodied in many different forms and should not be construed as limited to the exemplary embodiments set forth herein. In the description, details of well-known features and techniques may be omitted to avoid unnecessarily obscuring the presented embodiments.

Embodiments of the present invention relate generally to the field of computing, and more particularly, to automatically transforming client data to a common data normalization schema associated with a collaborative multi-client federated learning system while preserving data privacy. Therefore, the present invention may improve the technical field associated with machine learning and, more specifically federated learning (FL), by organizing multiple different client datasets into a structured form based on recommended and implemented data transformations to the client datasets. In turn, the present invention may greatly improve usability of a dataset. More specifically, data can be visualized more easily, insights could be extracted more efficiently, and information can be updated more quickly. Furthermore, risk of errors in a given dataset and/or in capturing data is reduced.

As previously described, federated learning is a sub-field of machine learning in which multiple entities or clients collaboratively train a model while ensuring that client data from each client remains decentralized. Specifically, federated learning aims at training a machine learning model/algorithm, for instance deep neural networks, on multiple local client datasets contained in local client nodes without explicitly exchanging data samples between clients. However, clients participating in a federated learning training process typically need to share a common encoding of values (or common format) between the various datasets associated with each client to, for instance, ensure that data from each dataset is being properly captured by a machine learning (ML) model for generating and training a global ML model. In such case, difficulties in forming a common encoding may arise when a global data schema or ontology is not known beforehand. Furthermore, while federated learning may be decentralized in nature, there is no guarantee that some shards of client data samples held by each client are not shared, oftentimes compromising data privacy for a client.

As such, it may be advantageous, among other things, to provide a method, computer system, and computer program product for automatically transforming client data to a common data normalization schema associated with a collaborative multi-client federated learning system while preserving data privacy. Specifically, the method, computer system, and computer program product may, for a client in the collaborative multi-client federated learning system comprising a plurality of clients, automatically generate a local data ontology based on client data associated with the client, and automatically generating synthetic data based on the client data and the local data ontology. The method, computer system, and computer program product may also include automatically computing an inference risk score and computing a task utility score for the synthetic data using one or more machine learning (ML) algorithms, wherein computing the inference risk score further comprises determining a privacy risk associated with sharing the synthetic data, and wherein computing the task utility score further comprises determining a utility of the synthetic data. The method, computer system, and computer program product may further include, based on the inference risk score and the task utility score, generating a global data ontology using ontology matching algorithms on the synthetic data associated with each local data ontology generated from each client from the plurality of clients in the collaborative multi-client federated learning system. The method, computer system, and computer program product may also include, based on the generated global data ontology, automatically recommending and implementing data transformations to the client data, wherein automatically recommending and implementing the data transformations further comprises automatically transforming the client data to the common data normalization schema based the global data ontology.

The present invention may be a computer system, a method, and/or a computer program product at any possible technical detail level of integration. The computer program product may include a computer readable storage medium (or media) having computer readable program instructions thereon for causing a processor to carry out aspects of the present invention.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer program product and computer readable storage medium, as those terms are used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed concurrently or substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The following described exemplary embodiments provide a system, method, and program product to determine whether directional input is received along with a query and, accordingly, adjust presented display content to include a referenced object in a center of a screen of a primary device.

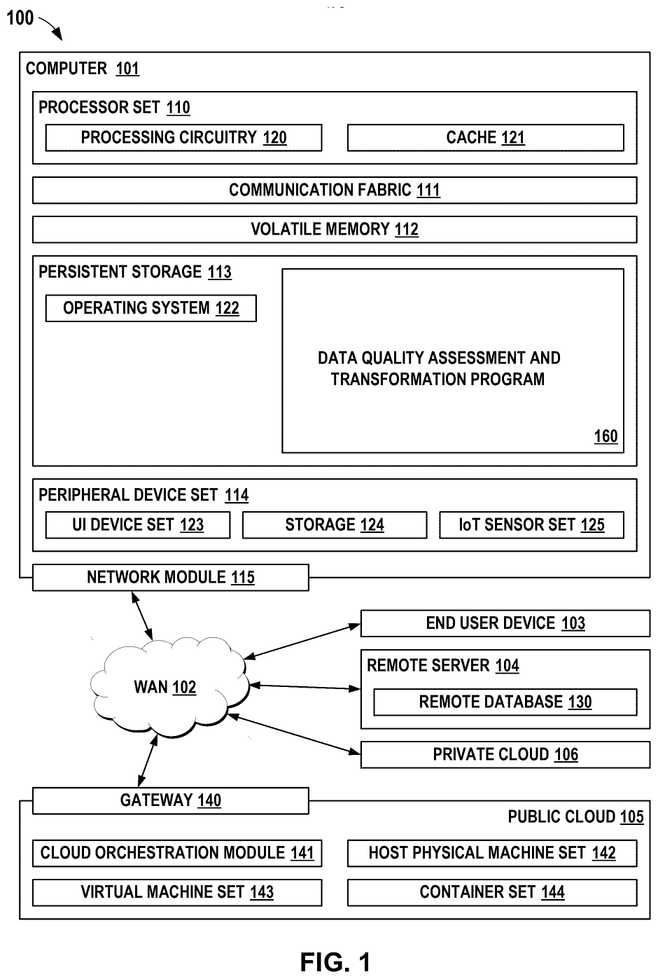

Referring to FIG. 1, an exemplary computing environment 100 is depicted, according to at least one embodiment. Computing environment 100 contains an example of an environment for the execution of at least some of the computer code involved in performing the inventive methods, such as a data quality assessment and transformation program 160. In addition to block 160, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 160, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

Computer 101 may take the form of a desktop computer, laptop computer, tablet computer, smart phone, smart watch or other wearable computer (such as a wearable headset), mainframe computer, quantum computer or any other form of computer or mobile device now known or to be developed in the future that is capable of running a program, accessing a network and/or querying a database, such as database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

Processor set 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 160 in persistent storage 113.

Communication fabric 111 is the signal conduction paths that allow the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

Volatile memory 112 is any type of volatile memory now known or to be developed in the future. Examples include dynamic type random access memory (RAM) or static type RAM. Typically, the volatile memory 112 is characterized by random access, but this is not required unless affirmatively indicated. In computer 101, the volatile memory 112 is located in a single package and is internal to computer 101, but, alternatively or additionally, the volatile memory 112 may be distributed over multiple packages and/or located externally with respect to computer 101.

Persistent storage 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage 113 allows writing of data, deletion of data and re-writing of data. Some familiar forms of persistent storage 113 include magnetic disks and solid state storage devices. Operating system 122 may take several forms, such as various known proprietary operating systems or open source Portable Operating System Interface type operating systems that employ a kernel. The code included in block 160 typically includes at least some of the computer code involved in performing the inventive methods.

Peripheral device set 114 includes the set of peripheral devices of computer 101. Data communication connections between the peripheral devices 114 and the other components of computer 101 may be implemented in various ways, such as Bluetooth connections, Near-Field Communication (NFC) connections, connections made by cables (such as universal serial bus (USB) type cables), insertion type connections (for example, secure digital (SD) card), connections made through local area communication networks and even connections made through wide area networks such as the internet. In various embodiments, UI device set 123 may include components such as a display screen, speaker, microphone, wearable devices (such as goggles, headsets, and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database), this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector and/or accelerometer.

Network module 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN may be replaced and/or supplemented by local area networks (LANs) designed to communicate data between devices located in a local area, such as a Wi-Fi network. The WAN 102 and/or LANs typically include computer hardware such as copper transmission cables, optical transmission fibers, wireless transmission, routers, firewalls, switches, gateway computers and edge servers.

End user device (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

Remote server 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

Public cloud 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 106 is similar to public cloud 105, except that the computing resources are only available for use by a single enterprise. While private cloud 106 is depicted as being in communication with WAN 102, in other embodiments the private cloud 106 may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

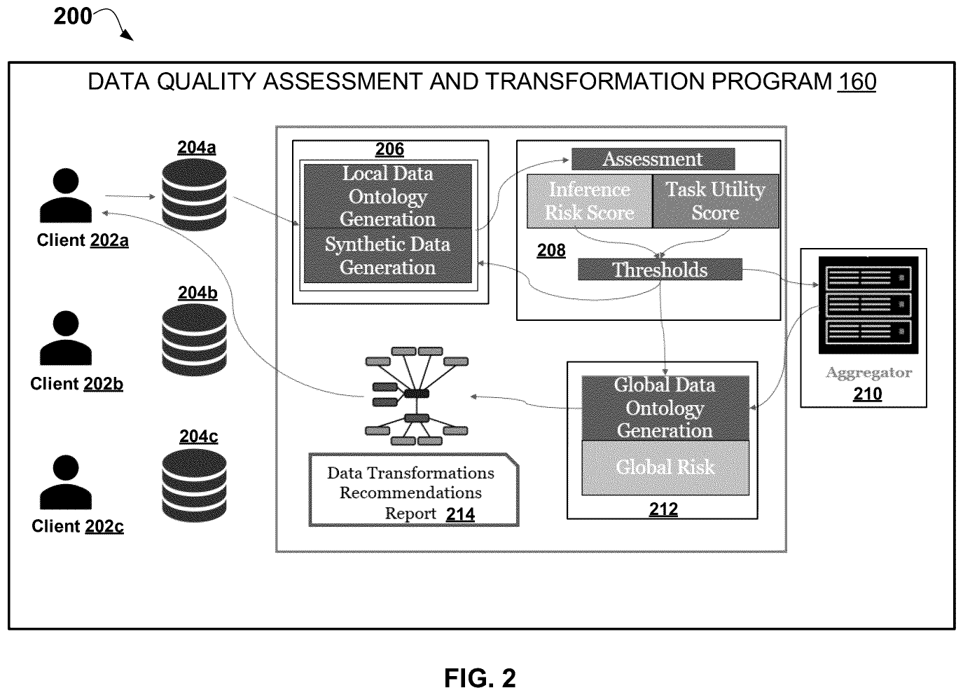

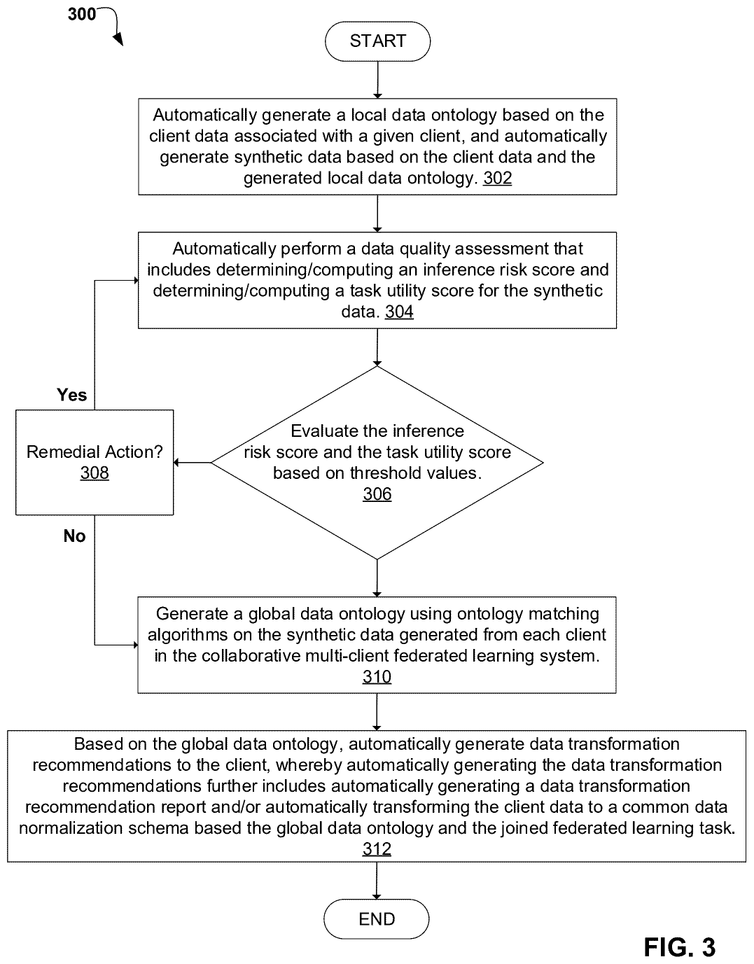

Furthermore, notwithstanding depiction in computer 101, the data quality assessment and transformation program 160 may be stored in and/or executed by, individually or in any combination, with end user device 103, remote server 104, public cloud 105, and private cloud 106. The data quality assessment and transformation program is explained in further detail below with respect to FIGS. 2-3.

According to the present embodiment, and as previously described, the data quality assessment and transformation program 160 may be a program/code capable of automatically transforming client data to a common data normalization schema associated with a collaborative multi-client federated learning system while preserving data privacy. Specifically, the data quality assessment and transformation program 160 may, for a client in the collaborative multi-client federated learning system comprising a plurality of clients, automatically generate a local data ontology based on client data associated with the client, and automatically generating synthetic data based on the client data and the local data ontology. The data quality assessment and transformation program 160 may also automatically compute an inference risk score and compute a task utility score for the synthetic data using one or more machine learning (ML) algorithms, wherein computing the inference risk score further comprises determining a privacy risk associated with sharing the synthetic data, and wherein computing the task utility score further comprises determining a utility of the synthetic data. The data quality assessment and transformation program 160 may, based on the inference risk score and the task utility score, further generate a global data ontology using ontology matching algorithms on the synthetic data associated with each local data ontology generated from each client from the plurality of clients in the collaborative multi-client federated learning system. The data quality assessment and transformation program 160 may also, based on the generated global data ontology, automatically recommend and implement data transformations to the client data, wherein automatically recommending and implementing the data transformations further comprises automatically transforming the client data to the common data normalization schema based the global data ontology.

Referring now to FIG. 2, a system component diagram 200 illustrating system components in a collaborative multi-client federated learning system associated with the data quality assessment and transformation program 160 according to one embodiment is depicted. As previously described, the data quality assessment and transformation program 160 may automatically transform client data to a common data normalization schema associated with a collaborative multi-client federated learning system while preserving data privacy. Accordingly, the data quality assessment and transformation program 160 may include different components as well as program/code for executing different computer operations/instructions described herein.

Specifically, the data quality assessment and transformation program 160 may include one or more clients 202a, 202b, 202c. According to one embodiment, a client may be a computing device such as the computer 101 described in FIG. 1 which, as previously described in FIG. 1, may take the form of a desktop computer, laptop computer, tablet computer, smart phone, smart watch or other wearable computer (such as a wearable headset), mainframe computer, quantum computer or any other form of computer or mobile device that is capable of running a program, accessing a network and/or querying a database. Furthermore, according to one embodiment, each client may include or be connected to a database, such as databases 204a, 204b, 204c depicted in FIG. 2, which may be used to store client data.

According to one embodiment, each client 202a, 202b, 202c may participate in the collaborative multi-client federated learning system. For example, each client may participate in the collaborative multi-client federated learning system by first identifying, via a user interface associated with the data quality assessment and transformation program 160, a federated learning task to join in the collaborative multi-client federated learning system, whereby the federated learning task may include a task to generate and/or train a global machine learning (ML) model/algorithm, for instance a deep neural network model, using federated learning by locally training an instance of the global ML model/algorithm on local client data that may be contained in local client nodes and/or databases, such as databases 204a, 204b, 204c associated with respective clients 202a, 202b, 202c. However, when initializing the federated learning task, and before generating and/or training the instance of the global ML model, the client data/dataset associated with a respective client 202a, 202b, 202c may first need to be normalized and/or transformed so that the clients participating in the federated learning task share a common encoding of values (i.e. common format) between the various client datasets to, for instance, ensure that data from each client is being properly captured and/or categorized when it is eventually used to train the global ML model. System components diagram 200 will be further described with respect to FIG. 3.

Referring to FIG. 3, an operational flowchart 300 for a program, such as the data quality assessment and transformation program 160, for automatically transforming client data to a common data normalization schema associated with the collaborative multi-client federated learning system while preserving data privacy is depicted. Specifically, and as depicted at 302 in FIG. 3 (as well as depicted at 206 in FIG. 2), the data quality assessment and transformation program 160 may, for a client 202a, 202b, and/or 202c (FIG. 2) in the collaborative multi-client federated learning system, automatically generate a local data ontology based on the client data associated with a given client and may automatically generate synthetic data based on the client data and the generated local data ontology. Specifically, and as known in the art, a data ontology is a way of identifying and linking data in various formats based on various concepts. More specifically, data ontologies may be knowledgebases that may include reference values for identifying both structured and unstructured information associated with a dataset to, in turn, identify concepts and categories associated with the dataset as well as identify properties and relationships between such information in the dataset. For example, a data ontology may include various taxonomies that describe client data (entities, document types, services, solutions, processes, business units, regions, roles, interests, addresses, products, and more) along with the relationships between these elements.

Thus, accordingly, at 302 in FIG. 3, based on the client data associated with a given client, such as client 202a, the data quality assessment and transformation program 160 may generate a data ontology (see also 206 in FIG. 2) for the client data. The data quality assessment and transformation program 160 may include known techniques/algorithms and/or leverage ML algorithms/programs (such as Virtuoso Sponger) specifically used to generate a local data ontology for a given client 202a based on the client data. Generally, for example, data ontology generation may begin with developing a controlled vocabulary to, for example, establish use of a same word for a particular meaning (such as always using “client” rather than a mix of “client,” “customer,” and “purchaser”). Accordingly, the data quality assessment and transformation program 160 may use a ML algorithm to identify terms that relate to a single concept. In a next stage, the data quality assessment and transformation program 160 may generate a taxonomy that defines relationships between the client data, such as a hierarchy of parent-child relationships. For example, a parent child relationship may be established for a product category, such as identifying one item being classified as part of another, or an engine being part of a car. Next, the data quality assessment and transformation program 160 may identify relationships among multiple taxonomies. In addition, a knowledge graph may be used to capture specific instances of a relationship, such as a between specific entities. In turn, based on the above example process, the data quality assessment and transformation program 160 may generate the local data ontology for a client.

Additionally, and to preserve privacy, the data quality assessment and transformation program 160 may further generate synthetic data based on the client data and the generated local data ontology. Specifically, synthetic data may be used instead of original client data, for example, as training data for building machine learning models and for providing a privacy safe version of a dataset when sharing data. Accordingly, the data quality assessment and transformation program 160 may use the local data ontology, as well as one or more ML algorithms (such as deep generative algorithms including generative adversarial network (GANs), variational autoencoders, normalizing flows, etc.) for generating the synthetic data. More specifically, for synthetic data generation, the data quality assessment and transformation program 160 may use the client data and the generated local data ontology as training data for a ML algorithm to learn the relationships, as well as correlations, statistical properties and data structures of the client data. Then, once trained, the ML algorithm can generate data that may be statistically and structurally identical to the original training client data, however, all of the data points are synthetic (i.e. the synthetic data may resemble the client data, however, the synthetic data is AI-generated and artificial). As such, the data quality assessment and transformation program 160 may generate the synthetic data (or synthetic data samples) which may be based on the client data and the generated local data ontology.

Then, at 304 in FIG. 3 (and as depicted at 208 in FIG. 2), the data quality assessment and transformation program 160 may automatically perform a data quality assessment that includes determining/computing an inference risk score and determining/computing a task utility score for the synthetic data, wherein computing the inference risk score includes determining a privacy risk associated with sharing the synthetic data, and wherein computing the task utility score includes determining a utility of the synthetic data. Specifically, the data quality assessment and transformation program 160 may compute the inference risk score for the synthetic data to inform a client of a current risk associated with sharing the synthetic data, for example, to generate a global data ontology. More specifically, while the synthetic data may be artificially generated as previously described, the synthetic data may still contain certain features and/or other data that may pose a potential privacy risk to the client, i.e. as a risk of exposing private features and/or client data. Furthermore, for the task utility score, the data quality assessment and transformation program 160 may determine the utility of the synthetic data or, in other words, how useful is the synthetic data in relation to the joined federated learning task.

According to one embodiment, the data quality assessment and transformation program 160 may assess the synthetic data for a privacy risk by determining/computing the inference risk score using one or more known algorithms/techniques which may include privacy evaluation framework algorithms (such as a member inference attack (MIA) classifier, k-anonymity, etc.). Furthermore, the data quality assessment and transformation program 160 may assess the synthetic data for utility by determining/computing the task utility score using one or more known algorithms/techniques which may be included in a synthetic data evaluation framework that may evaluate the synthetic data at a data sample level to determine whether the generated data sample is of high or low quality. The data quality assessment and transformation program 160 may additionally use other known evaluation algorithms/techniques (such as deep generative algorithms, including GANs and variational encoders) that may assess fidelity (how “good” are the synthetic data samples?), diversity (how much of the real client data is covered, and how representative is this?), and generalization (how often does the ML algorithm used for generating the synthetic data copy the training data?). In turn, according to one embodiment, the generated inference risk score and the generated task utility score may each be represented by a percentage. In an example, an inference risk score may represent as follows: 0-24% is a low risk of private features and/or other client data being shared, 25-44% is a low-to-medium risk of private features and/or other client data being shared, 45-54% is a medium risk of private features and/or other client data being shared, 55-74% is a medium-to-high risk of private features and/or other client data being shared, and 75-100% is a high risk of private features and/or other client data being shared. Similarly, the task utility score may be represented as follows: 0-24% indicates the synthetic data has a low utility, 25-44% indicates the synthetic data has a low-to-medium utility, 45-54% indicates the synthetic data has medium utility, 55-74% indicates the synthetic data has a medium-to-high utility, and 75-100% indicates the synthetic data has high utility. Thus, based on the computed percentages, the inference risk score may indicate a level of risk to privacy when sharing the synthetic data, and the task utility score may indicate a level of utility of the synthetic data.

Next, at 306 in FIG. 3 and as again depicted at 208 in FIG. 2, the data quality assessment and transformation program 160 may evaluate the inference risk score and the task utility score based on threshold values. Specifically, the data quality assessment and transformation program 160 may determine whether the inference risk score meets or exceeds a first threshold value and determine whether the task utility score meets or exceeds a second threshold value. According to one embodiment, each threshold value may either be a default threshold value included with or defined by the data quality assessment and transformation program 160 based on a given federated learning task or may be defined by a client (for example, by presenting a user interface associated with the data quality assessment and transformation program 160 on the client) in relation to a specific federated learning task (whereby the client may define different thresholds based on a type of federated learning task). Furthermore, each threshold value may be based on one or more rules that may be specific to a client and governs whether the synthetic data is shared based on the inference risk score and the task utility score. For example, for the synthetic data associated with client 202a, the data quality assessment and transformation program 160 may determine/compute an inference risk score of 56% and a task utility score of 92%. However, while the task utility score indicates that the synthetic data has a high utility (i.e. 92%), client 202a may have defined a first threshold value for the inference risk score where the client 202a prefers not to share any synthetic data having an inference risk score that meets or exceeds 50%. In another example, for client 202b, the data quality assessment and transformation program 160 may determine/compute an inference risk score of 6% and a task utility score of 26%. Accordingly, while the inference risk score indicates that the synthetic data only has a low risk of private information being shared (i.e. 6%), the federated learning task that the client 202b joined in the collaborative multi-client federated learning system may have a defined default second threshold value for the task utility score that requires the synthetic data to meet or exceed a 60% utility.

Therefore, and as depicted at 308 in FIG. 3, in each example presented above, a remedial action may be taken in response to the synthetic data meeting or exceeding the first threshold associated with the inference risk score and/or in response to the synthetic data not meeting or exceeding the second threshold associated with the task utility score. For example, in response to determining that the inference risk score meets or exceeds the first threshold value, the data quality assessment and transformation program 160 may generate a first notification to the client that includes the inference risk score and suggestions for reducing the privacy risk. For example, the data quality assessment and transformation program 160 may present a suggestion to the client 202a to generate more noisy client data samples for generating the synthetic data to help provide more privacy safe synthetic data. As such, a detected remedial action may include an action from the client 202a whereby the client generates more noisy client data samples. In such case, and going back to 304 in FIG. 3, the data quality assessment and transformation program 160 may subsequently assess newly generated synthetic data (i.e. compute a new inference risk score and new task utility score) based on the more noisy client data samples used to generate in the newly generated synthetic data. Alternatively, according to one embodiment, in response to the synthetic data meeting or exceeding the first threshold associated with the inference risk score, the data quality assessment and transformation program 160 may not receive remedial action. For example, the client 202a may be presented with the notification informing the client of the inference risk score and suggestions to reduce the privacy risk, however, the client may still select/elect (via a prompt) to proceed with sharing the synthetic data despite exceeding the defined threshold (i.e. 50%) associated with the inference risk score. Additionally, in the example of low utility from client 202b, the data quality assessment and transformation program 160 may present a notification on the client 202b indicating the task utility score as well as may provide a suggestion in the notification that synthetic data samples with a higher utility need to be generated. Thus, similarly, and going back to 304 in FIG. 3, the data quality assessment and transformation program 160 may subsequently assess newly generated synthetic data based on any remedial actions that were taken to help generate synthetic data with more utility.

Then, at 310, the data quality assessment and transformation program 160 may generate a global data ontology (also at 212 in FIG. 2) using ontology matching algorithms on the synthetic data generated from each client in the collaborative multi-client federated learning system. Specifically, and as previously described at step 302, the data quality assessment and transformation program 160 may first generate a local data ontology and synthetic data for each client a part of the federated learning task that is associated with the collaborative multi-client federated learning system. Thereafter, based on the assessment and any remedial actions performed at steps 306 and 308, respectively, and in response to detecting that synthetic data has been shared from a given client, the data quality assessment and transformation program 160 may include and use an aggregator (210 in FIG. 2) for aggregating the shared synthetic data from each client, whereby the synthetic data may include the local data ontology from a given client. In turn, the data quality assessment and transformation program 160 may use one or more known ontology matching algorithms/techniques for generating the global ontology based on the aggregated synthetic data. For example, the data quality assessment and transformation program 160 may use an ontology matching tool such as LogMap, a highly scalable ontology matching system with built-in reasoning and inconsistency repair capabilities. Specifically, using LogMap, the data quality assessment and transformation program 160 may identify and extract mappings between classes, properties, and instances associated with the synthetic data received from each client. In turn, using LogMap, the data quality assessment and transformation program 160 may efficiently match semantically rich ontologies containing tens and even hundreds of thousands of classes, incorporate sophisticated reasoning and repair techniques to minimize the number of logical inconsistencies between the various synthetic data, and provide support for user or client intervention during the matching process.

Additionally, the data quality assessment and transformation program 160 may determine/compute a global risk score (also at 212 in FIG. 2) for each client associated with the generated global data ontology. Similar to the inference risk score discussed above, the global risk score may provide an additional privacy check, whereby the data quality assessment and transformation program 160 may determine/compute a global risk score for each client by applying the previously described privacy evaluation framework to the global data ontology. Accordingly, the global risk score for a client may indicate a risk of exposing potentially private client data based on the global data ontology and given the information (or synthetic data) shared from each client while also considering privacy preferences (i.e. thresholds) from each client. The global risk score may similarly be represented by a percentage like the inference risk score described above.

Next, at 312, based on the global data ontology, the data quality assessment and transformation program 160 may automatically generate data transformation recommendations to the client, whereby automatically generating the data transformation recommendations further includes automatically generating a data transformation recommendation report and/or automatically transforming the client data to a common data normalization schema based the global data ontology and the joined federated learning task. Specifically, based on the generated global data ontology, as well as the federated learning task joined by the various clients, the data quality assessment and transformation program 160 may identify a common data normalization schema. According to one embodiment, the common data normalization schema may include data normalization rules for structuring client data in an organized common format to be shared by the various clients that are part of the joined federated learning task. Furthermore, the common data normalization schema may be based on the generated global data ontology.

For example, based on the aggregated synthetic data from each client 202a, 202b, 202c, the data quality assessment and transformation program 160 may determine, as part of generating the global data ontology, a common data normalization schema that includes a date format of DD-MM-YYYY (i.e. Day-Month-Year) which should be used as the common format between clients for any client data that includes dates. Specifically, according to one embodiment, the data quality assessment and transformation program 160 may identify this date format by aggregating the synthetic data from the various clients and determining that a majority (i.e. greater than or equal to 50%) of the clients (or synthetic data from the clients) uses the format DD-MM-YYYY. Alternatively, according to an embodiment, the data quality assessment and transformation program 160 may detect, based on the specific federated learning task joined by the clients, that the federated learning task specifically requires the date format of DD-MM-YYYY be used. For example, the joined federated learning task may have a mandate that requires client data that includes a date be represented as DD-MM-YYYY. In either case, the data quality assessment and transformation program 160 may include the date format in the global data ontology when generating the global data ontology. As such, in response to detecting a client, based on the synthetic data, using a different date format such as MM-DD-YYYY, the data quality assessment and transformation program 160 may automatically generate a data transformation recommendation to the client, whereby automatically generating the data transformation recommendation further includes automatically generating a data transformation recommendation report (at 214 in FIG. 2) on the client that includes a recommendation of transforming client data that includes dates of MM-DD-YYYY to the date format of DD-MM-YYY. Also, according to one embodiment, the data quality assessment and transformation program 160 may automatically transform the client data to the common data normalization schema based the global data ontology, such as by automatically transforming for a client 202a all client data that include the date format of MM-DD-YYYY to the date format DD-MM-YYYY.

Furthermore, in addition to providing the data transformation recommendations, the data quality assessment and transformation program 160 may further provide other information in the data transformation report (214 in FIG. 2) such as providing the determined/computed global risk score. In turn, the transformed client data may be used in a training process for locally training a global ML model. Specifically, by organizing multiple different client datasets into a structured form based on recommended and implemented data transformations to the client datasets, the data quality assessment and transformation program 160 may greatly improve usability of a dataset. More specifically, data can be visualized more easily, insights could be extracted more efficiently, and information can be updated more quickly. Furthermore, the risk of errors in data and in capturing data is reduced.

It may be appreciated that FIGS. 2-3 provide only illustrations of one implementation and does not imply any limitations with regard to how different embodiments may be implemented. Many modifications to the depicted environments may be made based on design and implementation requirements.

The present subject matter may comprise the following clauses.

Clause 1. A computer-implemented method, the computer-implemented method comprising: for a client in a collaborative multi-client federated learning system comprising a plurality of clients, automatically generating a local data ontology based on client data associated with the client, and automatically generating synthetic data based on the client data and the local data ontology; automatically computing an inference risk score and computing a task utility score for the synthetic data using one or more machine learning (ML) algorithms, wherein computing the inference risk score further comprises determining a privacy risk associated with sharing the synthetic data, and wherein computing the task utility score further comprises determining a utility of the synthetic data; based on the inference risk score and the task utility score, generating a global data ontology using ontology matching algorithms on the synthetic data associated with each local data ontology generated from each client from the plurality of clients in the collaborative multi-client federated learning system; and based on the generated global data ontology, automatically recommending and implementing data transformations to the client data, wherein automatically recommending and implementing the data transformations further comprises automatically transforming the client data to a common data normalization schema based the global data ontology.

Clause 2. The computer-implemented method of claim 1, wherein generating the global data ontology based on the inference risk score and the task utility score further comprises: determining whether the inference risk score meets or exceeds a defined privacy risk comprising a first threshold value; and in response to determining that the inference risk score meets or exceeds the defined privacy risk, generating a first notification to the client comprising the inference risk score and suggestions for reducing the inference risk score.

Clause 3. The computer-implemented method of claim 2, wherein generating the global data ontology based on the inference risk score and the task utility score further comprises: determining whether the task utility score meets or exceeds a defined utility requirement comprising a second threshold value; and in response to determining that the task utility score does not meet or exceed the defined utility requirement, generating a second notification to the client comprising the task utility score and suggestions for improving the task utility score.

Clause 4. The computer-implemented method of claim 3, wherein generating the global data ontology based on the inference risk score and the task utility score further comprises: detecting one or more first remedial actions in response to the determination that the inference risk score meets or exceed the defined privacy risk; and detecting one or more second remedial actions in response to the determination that the task utility score does not meet or exceed the defined utility requirement.

Clause 5. The computer-implemented method of claim 3, wherein generating the global data ontology based on the inference risk score and the task utility score further comprises: aggregating the synthetic data generated from the client in response to the determination that the inference risk score does not meet or exceed the defined privacy risk and the task utility score meets or exceeds the defined utility; and applying the ontology matching algorithms to the aggregated synthetic data.

Clause 6. The computer-implemented method of claim 1, wherein automatically recommending the data transformations further comprises: automatically generating and presenting a data transformation report comprising the recommended data transformations.

Clause 7. The computer-implemented method of claim 1, wherein the common data normalization schema comprises data normalization rules for structuring the client data in an organized common format to be shared by the plurality of clients.

Clause 8. A computer system for automatically transforming client data to a common data normalization schema associated with a collaborative multi-client federated learning system while preserving data privacy, comprising: one or more processors, one or more computer-readable memories, one or more computer-readable tangible storage devices, and program instructions stored on at least one of the one or more storage devices for execution by at least one of the one or more processors via at least one of the one or more memories, wherein the computer system is capable of performing a method comprising: for a client in the collaborative multi-client federated learning system comprising a plurality of clients, automatically generating a local data ontology based on the client data associated with the client, and automatically generating synthetic data based on the client data and the local data ontology; automatically computing an inference risk score and computing a task utility score for the synthetic data using one or more machine learning (ML) algorithms, wherein computing the inference risk score further comprises determining a privacy risk associated with sharing the synthetic data, and wherein computing the task utility score further comprises determining a utility of the synthetic data; based on the inference risk score and the task utility score, generating a global data ontology using ontology matching algorithms on the synthetic data associated with each local data ontology generated from each client from the plurality of clients in the collaborative multi-client federated learning system; and based on the generated global data ontology, automatically recommending and implementing data transformations to the client data, wherein automatically recommending and implementing the data transformations further comprises automatically transforming the client data to the common data normalization schema based the global data ontology.

Clause 9. The computer system of claim 8, wherein generating the global data ontology based on the inference risk score and the task utility score further comprises: determining whether the inference risk score meets or exceeds a defined privacy risk comprising a first threshold value; and in response to determining that the inference risk score meets or exceeds the defined privacy risk, generating a first notification to the client comprising the inference risk score and suggestions for reducing the inference risk score.

Clause 10. The computer system of claim 9, wherein generating the global data ontology based on the inference risk score and the task utility score further comprises: determining whether the task utility score meets or exceeds a defined utility requirement comprising a second threshold value; and in response to determining that the task utility score does not meet or exceed the defined utility requirement, generating a second notification to the client comprising the task utility score and suggestions for improving the task utility score.

Clause 11. The computer system of claim 10, wherein generating the global data ontology based on the inference risk score and the task utility score further comprises: detecting one or more first remedial actions in response to the determination that the inference risk score meets or exceed the defined privacy risk; and detecting one or more second remedial actions in response to the determination that the task utility score does not meet or exceed the defined utility requirement.

Clause 12. The computer system of claim 10, wherein generating the global data ontology based on the inference risk score and the task utility score further comprises: aggregating the synthetic data generated from the client in response to the determination that the inference risk score does not meet or exceed the defined privacy risk and the task utility score meets or exceeds the defined utility; and applying the ontology matching algorithms to the aggregated synthetic data.

Clause 13. The computer system of claim 8, wherein automatically recommending the data transformations further comprises: automatically generating and presenting a data transformation report comprising the recommended data transformations.

Clause 14. The computer system of claim 8, wherein the common data normalization schema comprises data normalization rules for structuring the client data in an organized common format to be shared by the plurality of clients.

Clause 15. A computer program product for automatically transforming client data to a common data normalization schema associated with a collaborative multi-client federated learning system while preserving data privacy, comprising: one or more tangible computer-readable storage devices and program instructions stored on at least one of the one or more tangible computer-readable storage devices, the program instructions executable by a processor, the program instructions comprising: for a client in the collaborative multi-client federated learning system comprising a plurality of clients, automatically generating a local data ontology based on the client data associated with the client, and automatically generating synthetic data based on the client data and the local data ontology; automatically computing an inference risk score and computing a task utility score for the synthetic data using one or more machine learning (ML) algorithms, wherein computing the inference risk score further comprises determining a privacy risk associated with sharing the synthetic data, and wherein computing the task utility score further comprises determining a utility of the synthetic data; based on the inference risk score and the task utility score, generating a global data ontology using ontology matching algorithms on the synthetic data associated with each local data ontology generated from each client from the plurality of clients in the collaborative multi-client federated learning system; and based on the generated global data ontology, automatically recommending and implementing data transformations to the client data, wherein automatically recommending and implementing the data transformations further comprises automatically transforming the client data to the common data normalization schema based the global data ontology.

Clause 16. The computer program product of claim 15, wherein generating the global data ontology based on the inference risk score and the task utility score further comprises: determining whether the inference risk score meets or exceeds a defined privacy risk comprising a first threshold value; and in response to determining that the inference risk score meets or exceeds the defined privacy risk, generating a first notification to the client comprising the inference risk score and suggestions for reducing the inference risk score.

Clause 17. The computer program product of claim 16, wherein generating the global data ontology based on the inference risk score and the task utility score further comprises: determining whether the task utility score meets or exceeds a defined utility requirement comprising a second threshold value; and in response to determining that the task utility score does not meet or exceed the defined utility requirement, generating a second notification to the client comprising the task utility score and suggestions for improving the task utility score.

Clause 18. The computer program product of claim 17, wherein generating the global data ontology based on the inference risk score and the task utility score further comprises: detecting one or more first remedial actions in response to the determination that the inference risk score meets or exceed the defined privacy risk; and detecting one or more second remedial actions in response to the determination that the task utility score does not meet or exceed the defined utility requirement.

Clause 19. The computer program product of claim 17, wherein generating the global data ontology based on the inference risk score and the task utility score further comprises: aggregating the synthetic data generated from the client in response to the determination that the inference risk score does not meet or exceed the defined privacy risk and the task utility score meets or exceeds the defined utility; and applying the ontology matching algorithms to the aggregated synthetic data.

Clause 20. The computer program product of claim 15, wherein the common data normalization schema comprises data normalization rules for structuring the client data in an organized common format to be shared by the plurality of clients.

As previously described, the present invention may be a system, a method, and/or a computer program product. The computer program product may include a computer readable storage medium (or media) having computer readable program instructions thereon for causing a processor to carry out aspects of the present invention. The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers, and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Java, Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

Furthermore, machine learning as described herein may broadly refer to machine learning algorithms that learn from data. More specifically, machine learning is a branch of artificial intelligence that relates to algorithms such as mathematical models that can learn from, categorize, and make predictions about data. Such mathematical models, which can be referred to as machine-learning models, can classify input data among two or more classes; cluster input data among two or more groups; predict a result based on input data; identify patterns or trends in input data; identify a distribution of input data in a space; or any combination of these. Examples of machine-learning models can include (i) neural networks; (ii) decision trees, such as classification trees and regression trees; (iii) classifiers, such as Naïve bias classifiers, logistic regression classifiers, ridge regression classifiers, random forest classifiers, least absolute shrinkage and selector (LASSO) classifiers, and support vector machines; (iv) clusters, such as k-means clusters, mean-shift clusters, and spectral clusters; (v) factorization machines, principal component analyzers and kernel principal component analyzers; and (vi) ensembles or other combinations of machine-learning models. Neural networks can include deep neural networks, feed-forward neural networks, recurrent neural networks, convolutional neural networks, radial basis function (RBF) neural networks, echo state neural networks, long short-term memory neural networks, bi-directional recurrent neural networks, gated neural networks, hierarchical recurrent neural networks, stochastic neural networks, modular neural networks, spiking neural networks, dynamic neural networks, cascading neural networks, neuro-fuzzy neural networks, or any combination of these.

1. A computer-implemented method for automatically transforming client data to a common data normalization schema associated with a collaborative multi-client federated learning system while preserving data privacy in training a global machine learning (ML) model, the computer-implemented method comprising:
for a client in the collaborative multi-client federated learning system comprising a plurality of clients, automatically generating a local data ontology based on the client data associated with the client, and automatically generating synthetic data based on the client data and the local data ontology;
automatically computing an inference risk score and computing a task utility score for the synthetic data using one or more machine learning (ML) algorithms, wherein computing the inference risk score further comprises determining a privacy risk associated with sharing the synthetic data, and wherein computing the task utility score further comprises determining a utility of the synthetic data;
based on the inference risk score and the task utility score, generating a global data ontology using ontology matching algorithms on the synthetic data associated with each local data ontology generated from each client from the plurality of clients in the collaborative multi-client federated learning system;
based on the generated global data ontology, automatically determining the common data normalization schema and implementing data transformations to the client data, wherein automatically implementing the data transformations further comprises automatically transforming the client data to the common data normalization schema based on the global data ontology; and
training the global ML model based on the transformed client data.

2. The computer-implemented method of claim 1, wherein generating the global data ontology based on the inference risk score and the task utility score further comprises:
determining whether the inference risk score meets or exceeds a defined privacy risk comprising a first threshold value; and
in response to determining that the inference risk score meets or exceeds the defined privacy risk, generating a first notification to the client comprising the inference risk score and suggestions for reducing the inference risk score.

3. The computer-implemented method of claim 2, wherein generating the global data ontology based on the inference risk score and the task utility score further comprises:
determining whether the task utility score meets or exceeds a defined utility requirement comprising a second threshold value; and
in response to determining that the task utility score does not meet or exceed the defined utility requirement, generating a second notification to the client comprising the task utility score and suggestions for improving the task utility score.

4. The computer-implemented method of claim 3, wherein generating the global data ontology based on the inference risk score and the task utility score further comprises:
detecting one or more first remedial actions in response to the determination that the inference risk score meets or exceed the defined privacy risk; and
detecting one or more second remedial actions in response to the determination that the task utility score does not meet or exceed the defined utility requirement.

5. The computer-implemented method of claim 3, wherein generating the global data ontology based on the inference risk score and the task utility score further comprises:
aggregating the synthetic data generated from the client in response to the determination that the inference risk score does not meet or exceed the defined privacy risk and the task utility score meets or exceeds the defined utility; and
applying the ontology matching algorithms to the aggregated synthetic data.

6. (canceled)

7. The computer-implemented method of claim 1, wherein the common data normalization schema comprises data normalization rules structuring the client data in an organized common format shared by the plurality of clients.

8. A computer system for automatically transforming client data to a common data normalization schema associated with a collaborative multi-client federated learning system while preserving data privacy in training a global machine learning (ML) model, comprising:
one or more processors, one or more computer-readable memories, one or more computer-readable tangible storage devices, and program instructions stored on at least one of the one or more storage devices for execution by at least one of the one or more processors via at least one of the one or more memories, wherein the computer system is capable of performing a method comprising:
for a client in the collaborative multi-client federated learning system comprising a plurality of clients, automatically generating a local data ontology based on the client data associated with the client, and automatically generating synthetic data based on the client data and the local data ontology;
automatically computing an inference risk score and computing a task utility score for the synthetic data using one or more machine learning (ML) algorithms, wherein computing the inference risk score further comprises determining a privacy risk associated with sharing the synthetic data, and wherein computing the task utility score further comprises determining a utility of the synthetic data;
based on the inference risk score and the task utility score, generating a global data ontology using ontology matching algorithms on the synthetic data associated with each local data ontology generated from each client from the plurality of clients in the collaborative multi-client federated learning system;
based on the generated global data ontology, automatically determining the common data normalization schema and implementing data transformations to the client data, wherein automatically implementing the data transformations further comprises automatically transforming the client data to the common data normalization schema based on the global data ontology; and
training the global ML model based on the transformed client data.

9. The computer system of claim 8, wherein generating the global data ontology based on the inference risk score and the task utility score further comprises:
determining whether the inference risk score meets or exceeds a defined privacy risk comprising a first threshold value; and
in response to determining that the inference risk score meets or exceeds the defined privacy risk, generating a first notification to the client comprising the inference risk score and suggestions for reducing the inference risk score.

10. The computer system of claim 9, wherein generating the global data ontology based on the inference risk score and the task utility score further comprises:
determining whether the task utility score meets or exceeds a defined utility requirement comprising a second threshold value; and
in response to determining that the task utility score does not meet or exceed the defined utility requirement, generating a second notification to the client comprising the task utility score and suggestions for improving the task utility score.

11. The computer system of claim 10, wherein generating the global data ontology based on the inference risk score and the task utility score further comprises:
detecting one or more first remedial actions in response to the determination that the inference risk score meets or exceed the defined privacy risk; and
detecting one or more second remedial actions in response to the determination that the task utility score does not meet or exceed the defined utility requirement.

12. The computer system of claim 10, wherein generating the global data ontology based on the inference risk score and the task utility score further comprises:
aggregating the synthetic data generated from the client in response to the determination that the inference risk score does not meet or exceed the defined privacy risk and the task utility score meets or exceeds the defined utility; and
applying the ontology matching algorithms to the aggregated synthetic data.

13. (canceled)

14. The computer system of claim 8, wherein the common data normalization schema comprises data normalization rules structuring the client data in an organized common format shared by the plurality of clients.

15. A computer program product for automatically transforming client data to a common data normalization schema associated with a collaborative multi-client federated learning system while preserving data privacy in training a global machine learning (ML) model, comprising:
one or more tangible computer-readable storage devices and program instructions stored on at least one of the one or more tangible computer-readable storage devices, the program instructions executable by a processor, the program instructions comprising:
for a client in the collaborative multi-client federated learning system comprising a plurality of clients, automatically generating a local data ontology based on the client data associated with the client, and automatically generating synthetic data based on the client data and the local data ontology;
automatically computing an inference risk score and computing a task utility score for the synthetic data using one or more machine learning (ML) algorithms, wherein computing the inference risk score further comprises determining a privacy risk associated with sharing the synthetic data, and wherein computing the task utility score further comprises determining a utility of the synthetic data;
based on the inference risk score and the task utility score, generating a global data ontology using ontology matching algorithms on the synthetic data associated with each local data ontology generated from each client from the plurality of clients in the collaborative multi-client federated learning system;
based on the generated global data ontology, automatically determining the common data normalization schema and implementing data transformations to the client data, wherein automatically implementing the data transformations further comprises automatically transforming the client data to the common data normalization schema based on the global data ontology; and
training the global ML model based on the transformed client data.

16. The computer program product of claim 15, wherein generating the global data ontology based on the inference risk score and the task utility score further comprises:
determining whether the inference risk score meets or exceeds a defined privacy risk comprising a first threshold value; and
in response to determining that the inference risk score meets or exceeds the defined privacy risk, generating a first notification to the client comprising the inference risk score and suggestions for reducing the inference risk score.

17. The computer program product of claim 16, wherein generating the global data ontology based on the inference risk score and the task utility score further comprises:
determining whether the task utility score meets or exceeds a defined utility requirement comprising a second threshold value; and
in response to determining that the task utility score does not meet or exceed the defined utility requirement, generating a second notification to the client comprising the task utility score and suggestions for improving the task utility score.

18. The computer program product of claim 17, wherein generating the global data ontology based on the inference risk score and the task utility score further comprises:
detecting one or more first remedial actions in response to the determination that the inference risk score meets or exceed the defined privacy risk; and
detecting one or more second remedial actions in response to the determination that the task utility score does not meet or exceed the defined utility requirement.

19. The computer program product of claim 17, wherein generating the global data ontology based on the inference risk score and the task utility score further comprises:
aggregating the synthetic data generated from the client in response to the determination that the inference risk score does not meet or exceed the defined privacy risk and the task utility score meets or exceeds the defined utility; and
applying the ontology matching algorithms to the aggregated synthetic data.

20. The computer program product of claim 15, wherein the common data normalization schema comprises data normalization rules structuring the client data in an organized common format shared by the plurality of clients.
